(19) United States
(12) Patent Application Publication
(10) Pub. No.: US 2019/0243026 A1
(43) Pub. Date: Aug. 8, 2019

(54) AUTOMATED METHOD FOR ENVIRONMENTAL HAZARD REDUCTION

(71) Applicant: LANDMARK GRAPHICS CORPORATION, Houston, TX (US)

(72) Inventors: Brent Charles HOUCHENS, Houston, TX (US); Joseph Blake WINSTON, Houston, TX (US); Feifei ZHANG, Spring, TX (US); Amir BAR, Houston, TX (US); Ankush AGRAWAL, Houston, TX (US); Paul SAAD, Houston, TX (US); Keshava RANGARAJAN, Sugar Land, TX (US); Olivier GERMAIN, Houston, TX (US)

(73) Assignee: LANDMARK GRAPHICS CORPORATION, Houston, TX (US)

(21) Appl. No.: 16/343,370

(22) PCT Filed: Apr. 27, 2017
(86) PCT No.: PCT/US2017/029761

§ 371 Date: Apr. 18, 2019

Related U.S. Application Data
(60) Provisional application No. 62/431,354, filed on Dec. 7, 2016.

(51) Int. Cl. G01V 99/00; E21B 41/00; G06Q 30/00; G06Q 50/02

(52) U.S. Cl. CPC G01V 99/005; G06Q 50/02; G06Q 30/018; E21B 41/0092

(57) ABSTRACT

A system including a work environment having a topology comprising a plurality of computing devices coupled with at least one of one or more sensors, one or more actuators, and one or more models. One or more processors communicatively coupled with the computing devices and having a memory having stored therein instructions which, when executed, cause the processors to generate, based on the topology, a graph for the work environment; collect respective parameters associated with the computing devices, sensors, actuators, and models; identify an environmental anomaly associated with at least one of the sensors; and generate a decision tree to determine a cause of the environmental anomaly.

### CROSS-REFERENCE TO RELATED APPLICATIONS

This application claims priority to U.S. Provisional Application No. 62/431,354, entitled “AUTOMATED METHOD FOR ENVIRONMENTAL HAZARD REDUCTION,” filed on Dec. 7, 2016, which is incorporated herein by reference in its entirety.

### TECHNICAL FIELD

The present technology pertains to the improvement of systems for monitoring and predicting environmental aspects of hydrocarbon exploration, drilling, well completion, production, transport, storage, and abandonment of wells. In particular, the present disclosure relates to the control, remediation, and reduction of environmental impact of hydrocarbon exploration, production, transport and storage.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary oilfield environment for implementation of the disclosure herein;

FIG. 2 illustrates a graph of an example system topology in an oilfield;

FIG. 3 illustrates a graph of an example topology of an oilfield;

FIG. 4 illustrates an example decision tree associated with an example condition;

FIGS. 5A-5D illustrate an exemplary method for monitoring of an oilfield environment, in accordance with the disclosure herein;

FIG. 6 illustrates an exemplary oilfield having multiple wells for implementation of the system, in accordance with the disclosure herein;

FIG. 7 is a flow chart illustrating a method of implementing the system to control a environmental anomaly, in accordance with the disclosure herein; and

FIGS. 8A and 8B illustrate schematic diagrams of example computing devices.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. The terms “comprising,” “including” and “having” are used interchangeably in this disclosure. The terms “comprising,” “including” and “having” mean to include, but not necessarily be limited to the things so described.

The term “sensor” may be defined as any device that can measure and report information regarding the immediate surroundings. Sensors used in accordance with the disclosure herein can be configured to detect at least one of, but not limited to, the presence of a specified chemical species, an optical change, an audio signal, the presence of radiation, and the presence of a biological.

Actuators that can be used in accordance with the present disclosure can include any device that is configured to modify its behavior, or the behavior of other devices, in response to a command signal.

The term “topology,” as used herein, may be defined as the arrangement of different components that make up a system. The term “graph,” as used herein, may be defined as a set of objects or locations (such as nodes, in the mathematical abstraction) in which some objects or locations are related in some sense through edges. The term “real-time data,” as used herein, may be defined as the continuous accumulation of data at specified intervals.

The term “oilfield,” as used herein, may be defined as any geological formation containing hydrocarbons, including liquid oils and gases, and the systems used to explore, detect, drill, and produce those hydrocarbons.

The term “model” (or “models”), as used herein, may be defined as including both physics-based and data-driven (or a combination thereof) interpretation and predictive algorithms.

Physics-based models can include models built on first-principles and laws of nature, which may include unknown parameters and require closure relations. Examples of physics-based models include conservation of mass, conservation of momentum, 1st and 2nd laws of thermodynamics, Maxwell's equations, and the like.

Data-driven models can include models that attempt to model actual real world data via various analysis techniques, and involve post hoc modeling of collected data. Examples include numerical analysis, mathematical analysis, curve fitting, classifying and clustering, with any variables not necessarily related to a physical variable or parameter. Data-driven models can utilize primary data and/or secondary data. Primary data include direct observations or measurements, and secondary data may include indirect measurements or inferences, including data from complex tests, such as formation permeability, skin factor, etc.

Finally, the term “hazard” (or “hazards”), as used herein, may be defined as any material for which controlled distribution is required, including, but not limited to, produced water, carbon dioxide (CO₂), heavy metals, radioactive materials, salts, chemical plumes, hydrocarbons, flow assurance chemicals (such as methanol, ethanol, inhibitors and the like), surfactants, proppants, carrier fluids, hydraulic fracture fluids, sand, and the like.

Many environmental hazards, including those both naturally occurring and human-made, can be associated with the exploration, production, and transportation of oil and gas. Disclosed herein is a method for using a system of sensors and actuators, communicatively coupled and dispersed throughout an oilfield, and both physics-based models and data-driven models to monitor an environment for the presence of an environmental anomaly (such as a hazard or a condition leading to a hazard). The distributed sensing system can be fixed, movable (for example, via self-piloted vehicles such as drones), or a combination thereof. Data modeling is carried out based on topology graphs of the oilfield, which can be continuously updated by the sensors, which can be configured to provide real-time information. Each respective graph can include computing devices, such as IoT (Internet of Things) devices, which can be coupled with one or more sensors, one or more actuators, and/or one or more models. The one or more models can include physics-based models, data-driven models, and/or hybrid models, for example. In some instances, an environmental compliance report can be automatically generated based on the real-time data and sent to the necessary groups, including, but not limited to, government officials.

The described system may be a reactive system. For instance, when an environmental anomaly (such as a hazard) is detected, the network of sensors can automatically communicate with one another to determine the source of the environmental anomaly. The distributed network of sensors and computing devices can be capable of running both physics-based and data-driven models. As a result, the system can interpret the cause and effect of the environmental anomaly at a high level, and can be configured to automatically send warnings regarding the anomaly location and possible dispersion to stakeholders, first responders, and any other relevant groups of people. Additionally, a control system can automatically respond by activating actuators throughout the system including, but not limited to, actuators controlling valves, pumps, blow out preventers (BOPs), and separators in order to minimize the impact of the environmental anomaly. The real-time collection, modeling, and report generation process can be continuously repeated until the environmental anomaly is contained and/or remediated.

In the alternative, the described system may be a proactive system. For example, if a non-hazardous, but also non-optimum, environmental anomaly is detected (including, but not limited to, high water cut production) the system can be configured to automatically adjust one or more of the actuators (described above) in the area of the non-hazardous anomaly. Models of the non-hazardous anomaly can be automatically, and continuously, updated with real-time information gathered from the distributed sensors in order to improve the efficiency of the overall system. The system may be configured to minimize the occurrence of non-optimum situations including, but not limited to, an excess amount of produced water. Accordingly environmental anomalies encompass both hazardous and non-hazardous conditions, but which may be sub-optimal or deviate from what is expected or typical in an oilfield.

Additionally, the system, whether reactive or proactive, can include a plurality of distributed non-toxic, or non-reactive, tracers in order to assist in the location and determination of the root-cause analysis of the anomaly. Tracers compatible for use with system described herein can be automatically released by one or more actuators and injected into a transportation media, such as drilling mud, air, or water. Once deployed, the distributed sensor network can provide updates to the distributed models based on information transmitted and received from the tracers.

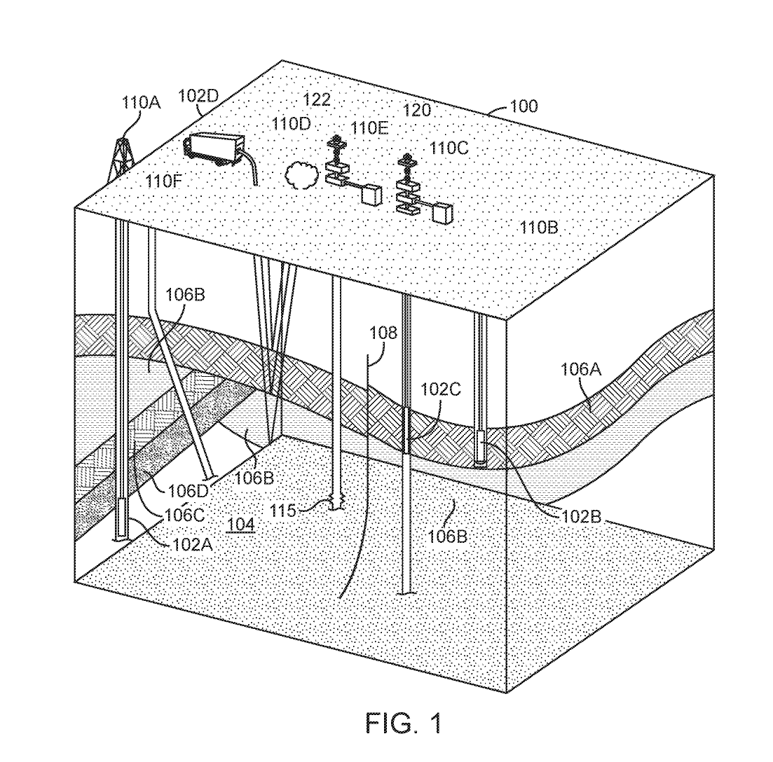

An exemplary oilfield in which the present disclosure may be implemented is illustrated in FIG. 1. The oilfield 100 can include multiple wells 110A-F which may have tools 102A-D for data acquisition. The multiple wells 110A-F may target one or more hydrocarbon reservoirs. Moreover, the oilfield 100 has distributed network of sensors and computing devices positioned at various locations for sensing, collecting, analyzing, and/or reporting data. A plurality of tracers may also be distributed about the oilfield 100. For instance, well 110A illustrates a drilled well having a wireline data acquisition tool 102A suspended from a rig at the surface for sensing and collecting data, generating well logs, and performing downhole tests which are provided to the surface. Well 110B is currently being drilled with drilling tool 102B which may incorporate subs and additional tools for logging while drilling (LWD) and/or measuring while drilling (MWD). Well 110C is a producing well having a production tool 102C. The tool 102C is deployed from a Christmas tree 120 at the surface (having valves, spools, and fittings). Fluid flows through perforations in the casing (not shown) and into the production tool 102C in the wellbore to the surface. Well 110D illustrates a well having blowout event from an underground reservoir. The tool 102D may permit data acquisition by a geophysicist to determine characteristics of a subterranean formation and features, including seismic data. Well 110E is undergoing fracturing and having initial fractures 115, with pumping equipment 122 at the surface. Well 110F is an abandoned well which had been previously drilled and produced.

The oilfield 100 can include a subterranean formation 104, which can have multiple geological formations 106A-D, such as a shale layer 106A, a carbonate layer 106B, a shale layer 106C, and a sand layer 106D. In some cases, a fault line 108 can extend through one or more of the layers 106A-D.

Sensors may be provided around the oilfield 100, multiple wells 110A-F and tools 102A-D. The data collected by such sensors and tools 102A-D can be used to generate graphs, models, predictions, monitor conditions and/or operations, describe properties or characteristics of components and/or conditions in the oilfield 100, manage conditions and/or operations in the oilfield 100, analyze and adapt to changes in the oilfield 100, etc. The data can include, for example, properties of formations or geological features, physical conditions in the oilfield 100, events in the oilfield 100, parameters of devices or components in the oilfield 100, etc.

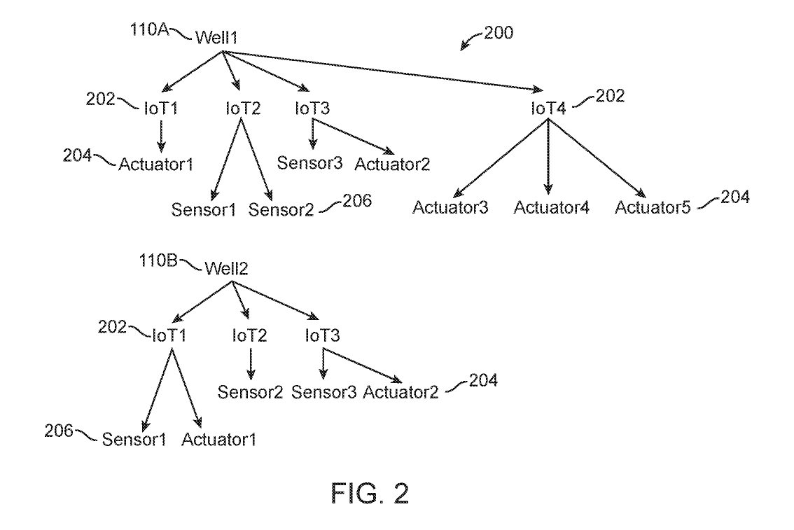

FIG. 2 illustrates an example system topology 200 for monitoring environmental hazards and management of an oilfield, such as oilfield 100 shown in FIG. 1A. The topology 200 can include wells 110A-B, and each well can include one or more associated sensors 206 and/or actuators 204. Each well 110A, 110B can have a graph that is directed from the respective well 110A, 110B, to the computing devices 202, which are shown as IoT in FIG. 2, and continuing to the sensor(s) 206 and actuator(s) 204 attached to their respective computing device 202. This graph can be used to detect environmental hazards in a work environment such as an oilfield.

For example, if there is no information from IoT2, then the lack of information from IoT2 can suggest a problem with IoT2. On the other hand, if IoT2 is available or functioning but Sensor1 and Sensor2 are not reporting data or lack connectivity, the lack of information from these sensors may suggest issues with these sensors.

Data and conditions from the computing devices 202, actuators 204, and sensors 206 can be collected and monitored to quickly identify problems and solutions on wells 110A, 110B. Knowledge of the topology 200 can help identify which specific component may be having an issue as previously mentioned.

Wells 110A-B are illustrated as non-limiting examples for clarity and explanation. One of ordinary skill in the art will recognize that other examples or implementations may have more or less wells.

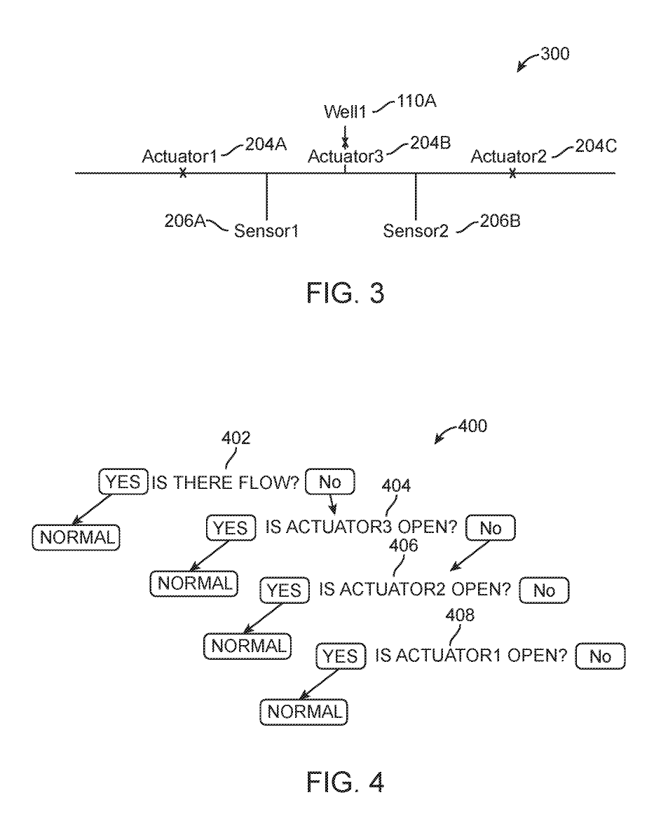

FIG. 3 illustrates an example topology 300 of an oilfield (e.g., oilfield 100). In this case, there is one well 110A (Well1), three actuators 204A-C (Actuator1, Actuator2, Actuator3), and two sensors 206A-B (Sensor1 and Sensor2). Inferences, predictions, and calculations can be made based on the topology 300.

For example, if all the actuators 204A-C are valves, then when Actuator1, Actuator2, and Actuator3 are closed, Sensor1, a flow sensor, must measure no flow. If there is flow at Sensor1, then either an actautor failed to close complely or there is a leak. As another example, if Sensor2 is a pressure device, a pressure near 1 atmosphere would indicate that the pressure inside the pipe is almost the same as the pressure outside of the pipe.

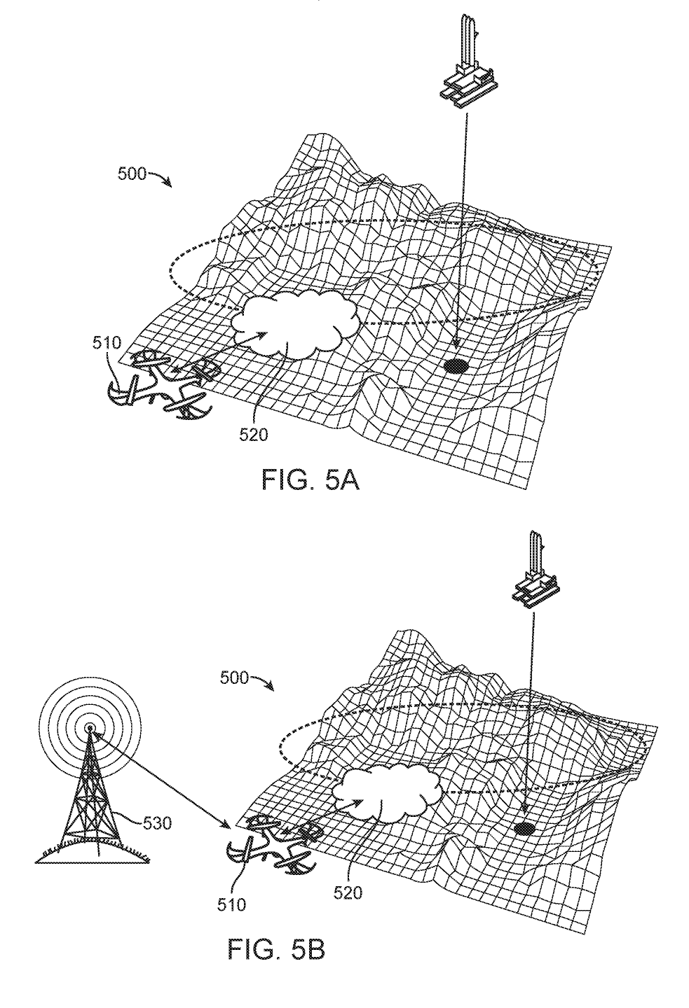

The information from FIGS. 2 and 3, describing the topology of the hardware, software, sensors, and actuators along with the topology of the oilfield, can be combined into a decision tree that assists in identifying the root-cause of a condition, such as a failure or inefficiency. FIG. 4 illustrates a partial decision tree 400 for determining why there is no flow in a topology of sensors and actuators such as topology 300 shown in FIG. 3. For clarity and simplicity, not shown in FIG. 4 is the complete tree that takes into account failure of the sensors 206, actuators 204, and IoT devices 202.

As illustrated in FIG. 4, a decision 402 is made on whether there is a flow. If there is a flow, then the status is normal. If there is no flow detected, then a decision 404 is made to determine whether Actuator3 is open. If Actuator3 is open, then the status is normal. If the Actuator3 is not open, then a decision 406 is made on whether Actuator2 is open. If Actuator2 is determined to be opened, then the status is normal. If the Actuator2 is not open, then a decision 408 is made on whether Actuator1 is open. Again, if Actuator1 is open, the status is normal. On the other hand, if Actuator1 is not open, then a problem or failure is detected. The problem or failure in this example can be an unexpected flow, such as a leak of a VOC, which may be an environmental hazard.

Having disclosed example systems and environments, the disclosure now turns to a general discussion of an automated method for the reduction of potential environmental hazards.

Physics-based and/or data-driven models in conjunction with real-time data, sensors, and actuators are used to construct a methodology that can in real-time adjust the physics hardware in wells, such as valves, chokes, pumps, separators, etc., and thus improve performance and ability to meet predetermined objectives.

The interaction of the system with the oil field is not restricted to simply controlling a single device on an identified well. Rather, the ensemble can adjust actuators directly or indirectly, as required, automatically.

The following illustrates exemplary environmental anomalies and how the same may be monitored and appropriate action taken using the disclosed distributed network of sensors and actuators, communicatively coupled and dispersed throughout an oilfield, along with processors and the use of both physics-based models and data-driven models. The examples are not intended to limit the scope of the present disclosure and should not be so interpreted.

### EXAMPLE 1—WELLBORE VOCS

An oilfield compatible for use with the disclosed system can include wells that are currently being drilled, wells that are already drilled but not yet completed, wells that are completed (including, but not limited to, producing wells), and wells that are abandoned. A network of sensors distributed throughout the oilfield can be used to monitor for the release of volatile organic compounds (VOCs). Such increases of VOC can be the result of, but is not limited to, a wellbore blowout, well-control event, and oil spill. When an increased presence of a VOC is detected, the system can determine, and automatically generate, a compliance report showing whether the field still adheres to government regulations. When the level of VOC increases to a higher, but still acceptable, level, the sensors can communicate with one another to determine the root-cause of the VOC release. In at least one scenario, more than one sensor identifies a VOC release (or plume). In this scenario, the phenomena can be reflective of a reality where a leak has occurred. Calculations can be performed on the distributed network, using both data-driven and physics-based models, to determine the cause of the plume and generate a warning and/or report, as needed. In an alternative scenario, if only one sensor detects the VOC release, it is possible that the sensor is malfunctioning; a corresponding warning and report can be generated. The automated reporting method can be used for either a short period of time (such as during high risk situations), or can be maintained throughout the life of the field, including monitoring abandoned wells for leakage.

### EXAMPLE 2—CONTAMINANTS

Environmental anomalies, such as contamination, can occur at several points throughout the hydrocarbon exploration process. For example, contaminants can be released during the drilling process, the completion process (including conventional wells, unconventional wells, hydraulically fractured wells, etc.), and the production process. Such environmental contaminants can include, but are not limited to, liquid organics, heavy metals, muds, cuttings, radioactive materials, salts, biological materials, chemical materials (such as chemicals used for flow assurance, e.g. methanol), surfactants, proppants, carrier fluids, fracture fluids, and the like. These contaminants can be released both above and below ground throughout the lifetime of the oilfield.

For example, if environmental contaminants are released above the surface of the oilfield, the contamination can impact the environment in a variety of ways. For example, the impact can include, but is not limited to, airborne dispersion, ground leaching (onshore), and water contamination (offshore, or onshore, including oilfields near bodies of water and/or aquifers).

In the alternative, environmental contaminants that are released below ground can include, but are not limited to, surfactants, hydrocarbon plumes, benzene, and combinations thereof. Such environmental contaminants can be both naturally occurring within the formation, and materials introduced in conjunction with the drilling, completion, and production process (as described above). For example, excessive depletion of the reservoir during the production process can lead to subsidence and casing, or cement, failure. Such failures can lead to hydrocarbon penetration of subsurface formations, including aquifers. Additionally, accidental spills can release any of the above described contaminants into the air, ground, and water.

The distributed network of sensors and/or tracers can be employed to detect the contaminants both above and below ground. Calculations can be performed on the distributed network, using both data-driven and physics-based models, to determine whether contaminants were released, potential cause, and generate a warning and/or report.

### EXAMPLE 3—PIPELINE LEAKS

A network of sensors can be used to monitor a pipeline transporting oil and/or natural gas (with or without water) and storage vessels. The sensors can be used to detect the release of VOCs, including, but not limited to, liquids (including oil and water) and heavy metals. The system can be configured to automatically generate a compliance report showing whether or not the pipeline is free of leaks. For example, the compliance report can show that a detected leak is sufficiently small, and any released VOCs remain within government mandated compliance levels. In the alternative, if a substantial leak is identified, the network of sensors can communicate with one another to determine the root-cause of the leak using both data-driven and physics-based models. The information gathered by the sensors can be used to determine the problem that is most likely to have caused the leak, generate and transmit a warning to those who may be working in the area, and generate any necessary government compliance reports.

When a leak is identified which produces a hazard that exceeds safety limits (such as government compliance thresholds), the system can communicate with the distributed network of actuators (such as those controlling valves) which can be triggered to automatically respond and attempt to remediate the leak. The models can be used to predict the most likely impact of contaminants (gaseous or liquid) on the surrounding area (including, but not limited to, people, local wildlife, and the surrounding environment). The system can also provide a real-time suggested remediation strategy for first responders based on the predicted impact.

The distributed network, as described above, can also be used to facilitate communication of the sensor readings. For example, when a sensor detects an environmental anomaly, the reading can be transmitted from a remotely located sensor to one or more reporting stations at a locations at a more accessible portion of the pipeline. Such locations can include, but are not limited to, the head of the pipeline, the tail of the pipeline, and critical junctures there between.

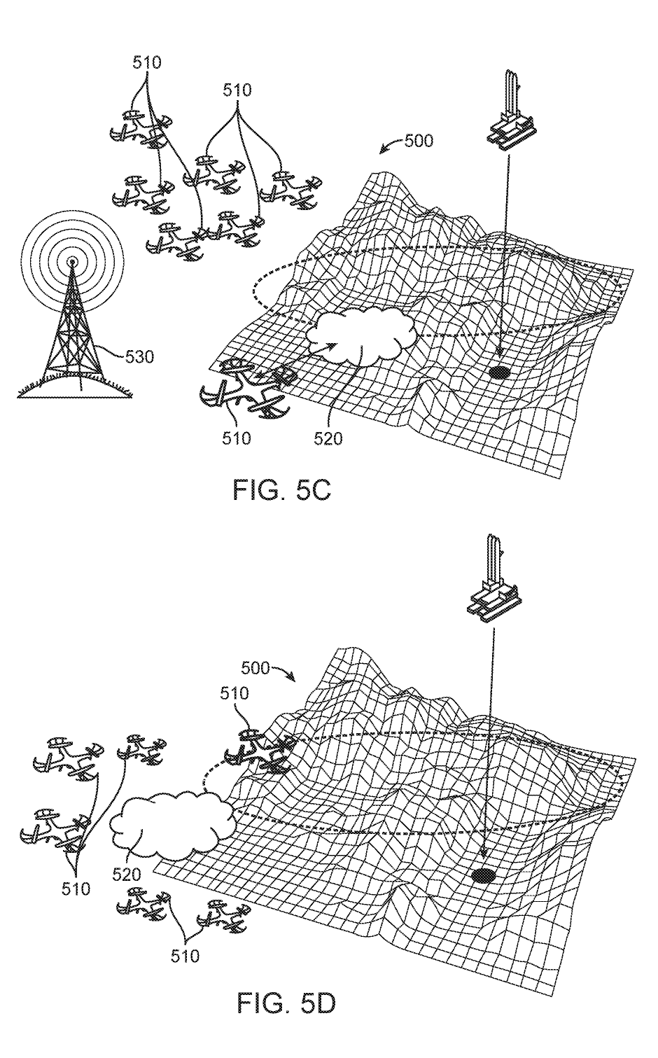

FIGS. 5A-D illustrate a method of detecting and monitoring an environmental anomaly with the use of vehicles, in accordance with the disclosure herein. FIG. 5A-D illustrates an oilfield 500 compatible for use with the system disclosed herein. The sensors distributed throughout the oilfield can be located on vehicles 510 including, but not limited to, air (such as drones), ground, water, and deep water vehicles. Use of such vehicles allows for faster inspection of remote locations and the ability to move along the length of a detected anomaly in order to help determine the source. The vehicles can be communicatively coupled with one another and can provide additional methods for inspection during both normal operation and at times of higher risk. The vehicles can also be used for several other purposes, including, but not limited to, assisting in emergency response detection, reporting information to first responders, relaying information after natural disasters when conditions are unknown or unreachable (including, but not limited to, earthquakes and hurricanes), and during equipment failures (such as pipeline leaks).

In FIG. 5A a sensor located on an aerial vehicle, such as a drone, is used to patrol the oilfield; the sensor can be triggered when an environmental anomaly 520, such as a chemical plume, is identified. In FIG. 5B, the aerial vehicle can locate and transmit the location of the environmental anomaly 520 to a reporting station 530 (such as a base), to request additional sensors be deployed in order to track the origin and distribution of the plume. In FIG. 5C, additional aerial vehicles 510 are deployed, each of which have a sensor, in order to better monitor the anomaly 520. Finally, in FIG. 5D, the aerial vehicles 510 remain in the area of the anomaly 520 in order to detect any real-time changes and monitor the progression (or dispersion) of the plume.

### EXAMPLE 4—CONTROL OF NON-HAZARD ANOMALY

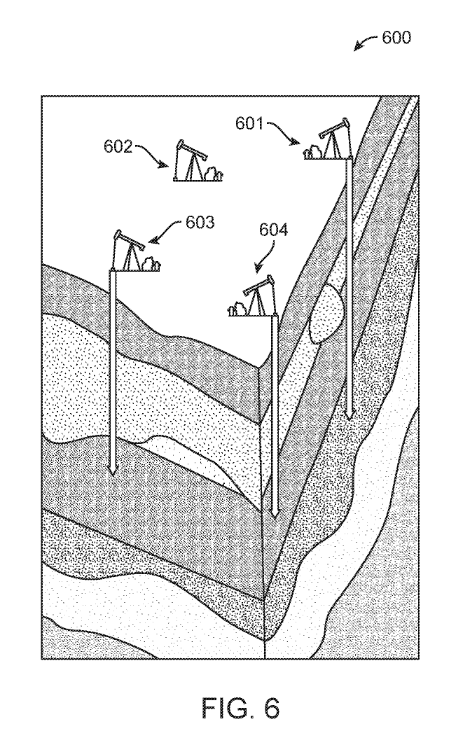

According to the disclosure herein, the distributed network of sensors as disclosed herein can be employed to control an oilfield and take proactive measures in view of a non-hazard environmental anomaly. For instance, with respect to FIG. 6 having oilfield 600, water production can be controlled after sensing a high water cut. A producing oilfield 600 having several wells 601, 602, 603, 604, separators, and collection lines can be monitored by the above described distributed network of sensors. Each well can contain one or more control devices including, but not limited to, chokes, downhole valves, downhole sleeves, inflow control devices, artificial lift devices (such as pumps), and combinations thereof. For example, as shown in FIG. 6, a first well 601 is producing significant water cut, while the other wells 602, 603, 604 are primarily producing the desired hydrocarbons. The high water cut can be sensed by the distributed network and a local model of the field can be generated. The generated model can be used to determine that a first well 601 would better serve as an injection well. In response, valves located throughout the oilfield 600 can be actuated in order to divert the water from separators located at wells 602, 603, 604 to the first well 601. Additionally, or alternatively, the first well 601 can contain novel completions that allow it to be transitioned from a producing to an injecting well. Thus, produced water can be returned directly to the reservoir, increasing the pressure within the reservoir, increasing productivity in wells 602, 603, and 604, and eliminating the need to transport and treat wastewater offsite, thereby limiting water treatment requirements.

While several embodiments have been described in detail in the foregoing description, the same is to be considered as illustrative and not restrictive in character, it being understood that only some embodiments have been shown and described and that all changes and modifications that come within the spirit of the embodiments are desired to be protected.

Additionally, while Examples 1-4 generally depict work environments having an oilfield with at least one well, it would be understood to those having skill in the art that the disclosed methods and systems can be used in a variety of different work environments. For example, the work environment can be, but is not limited to, a field comprising a plurality of wells, a pipeline, a collection line, a network of pipelines, a network of collection lines, a storage device, a network of storage devices, and combinations thereof.

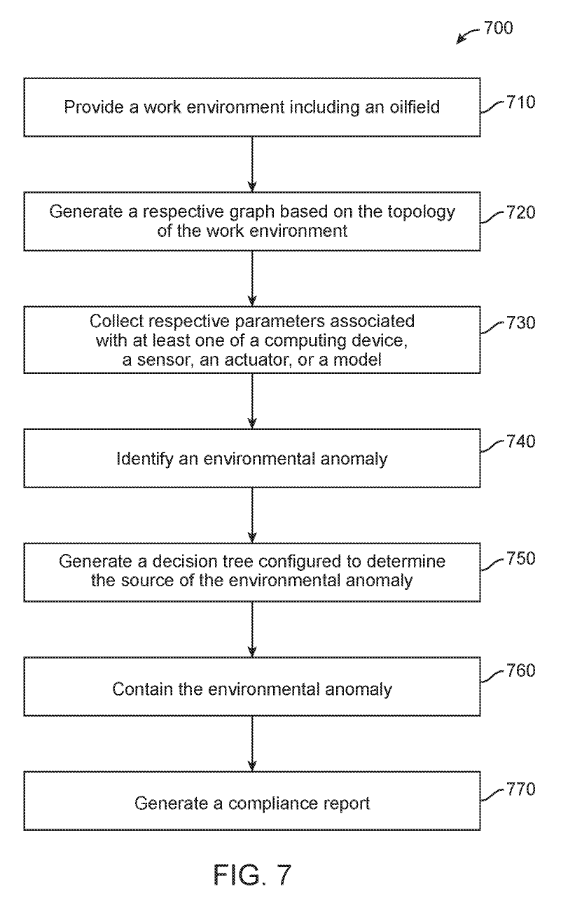

A method 700 for implementing the systems described above is shown in FIG. 7. At step 710, a work environment is provided. The work environment can include an oilfield having one or more wells, the field can be in any state of production including, but not limited to, prior to drilling, drilling, producing, and post-production. At step 720, a respective graph is generated based on the topology of the work environment. At step 730, respective parameters are collected; the parameters can be associated with one of a computing device, a sensor, an actuator, or a model. In the alternative, the parameters can be associated with multiple computing devices, sensors, actuators, or models. At step 740, an environmental anomaly is identified based on the collected parameters. As discussed above, the environmental anomaly can include, but is not limited to, the presence of either a hazardous or non-hazardous material.

Once the environmental anomaly has been identified, at step 750 the network of computing devices can generate a decision tree. The decision tree can be configured to evaluate the respective parameters collected and determine the source of the environmental anomaly. Next, at step 760 the system can activate one or more actuators throughout the work environment in order to contain the environmental anomaly. For example, if the detected environmental anomaly is a leak, one or more actuators in the area around the leak can be triggered to divert flow away from the leak location. In at least one scenario, once flow is diverted away from the leak location workers are able to better repair any damage. Finally, at step 770, the system can automatically generate a compliance report detailing information on the type of hazard and likely dispersion path. The compliance report can also be automatically sent to one or more groups of people including, but not limited to, government officials, first responders, workers in the surrounding area, and stakeholders in the work environment.

As can be apprehended by the preceding discussion, the present disclosure includes collaboration of devices and models and can provide a fully automated control of devices (including, but not limited to, valves, chokes, artificial lift, pumps, separators, and slug catchers) with automated feedback and reporting. The methods can be performed on a fully automated system, without the need for human intervention or control. Additionally, the present disclosure focuses on a method and system designed around environmental impact, not maximization of production or economic impact (aside from avoidance of penalties relating to environmental issues), and compliance reporting. The system can also include movable sensors, each of which have their own computing and decision making abilities.

The system that can be entirely automated to monitor, locate, and remediate environmental risks, as well as automatically produce and deliver compliance reports to the necessary officials. The system eliminates the need for human collection of samples. The removal of human interaction allows for a safer way to interpret data in potentially hazardous situations. The present disclosure automatically adapt a field to any new compliance standards (such as those based on VOC levels) including, but not limited to, monitoring of abandoned wells for leakage. The system can be activated remotely at a minimal cost without infrastructure changes and without the need to send workers into the field.

Accordingly as disclosed herein, a field, such as an oilfield, is optimized by minimizing environmental impact. The minimization of environmental impact can also lead to the subsequent minimization of fines and automation of compliance standards.

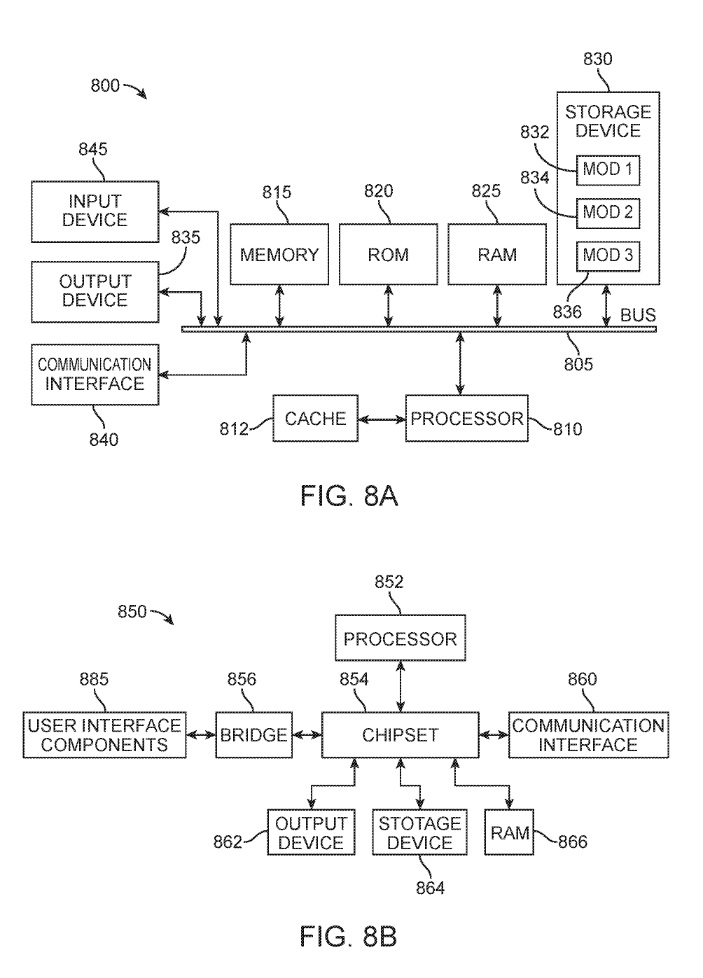

As one of ordinary skill in the art will recognize, one or more of the systems and methods described herein can be performed by one or more computing devices, such as system 800 and/or 850 described with respect to FIGS. 8A and 8B. Moreover, one or more of the steps described herein can be automatic, automated, dynamic, and/or in real-time or substantially in real-time.

FIG. 8A illustrates an example computing device which can be employed to perform various steps, methods, and techniques disclosed above. The more appropriate embodiment will be apparent to those of ordinary skill in the art when practicing the present technology. Persons of ordinary skill in the art will also readily appreciate that other system embodiments are possible.

Example system and/or computing device 800 includes a processing unit (CPU or processor) 810 and a system bus 805 that couples various system components including the system memory 815 such as read only memory (ROM) 820 and random access memory (RAM) 825 to the processor 810. The processors disclosed herein can all be forms of this processor 810. The system 800 can include a cache 812 of high-speed memory connected directly with, in close proximity to, or integrated as part of the processor 810. The system 800 copies data from the memory 815 and/or the storage device 830 to the cache 812 for quick access by the processor 810. In this way, the cache provides a performance boost that avoids processor 810 delays while waiting for data. These and other modules can control or be configured to control the processor 810 to perform various operations or actions. Other system memory 815 may be available for use as well. The memory 815 can include multiple different types of memory with different performance characteristics. It can be appreciated that the disclosure may operate on a computing device 800 with more than one processor 810 or on a group or cluster of computing devices networked together to provide greater processing capability. The processor 810 can include any general purpose processor and a hardware module or software module, such as module 1 832, module 2 834, and module 3 836 stored in storage device 830, configured to control the processor 810 as well as a special-purpose processor where software instructions are incorporated into the processor. The processor 810 may be a self-contained computing system, containing multiple cores or processors, a bus, memory controller, cache, etc. A multi-core processor may be symmetric or asymmetric. The processor 810 can include multiple processors, such as a system having multiple, physically separate processors in different sockets, or a system having multiple processor cores on a single physical chip. Similarly, the processor 810 can include multiple distributed processors located in multiple separate computing devices, but working together such as via a communications network. Multiple processors or processor cores can share resources such as memory 815 or the cache 812, or can operate using independent resources. The processor 810 can include one or more of a state machine, an application specific integrated circuit (ASIC), or a programmable gate array (PGA) including a field PGA (FPGA).

The system bus 805 may be any of several types of bus structures including a memory bus or memory controller, a peripheral bus, and a local bus using any of a variety of bus architectures. A basic input/output (BIOS) stored in ROM 820 or the like, may provide the basic routine that helps to transfer information between elements within the computing device 800, such as during start-up. The computing device 800 further includes storage devices 830 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 830 can include software modules 832, 834, 836 for controlling the processor 810. The system 800 can include other hardware or software modules. The storage device 830 is connected to the system bus 805 by a drive interface. The drives and the associated computer-readable storage devices provide nonvolatile storage of computer-readable instructions, data structures, program modules and other data for the computing device 800. In one aspect, a hardware module that performs a particular function includes the software component stored in a tangible computer-readable storage device in connection with the necessary hardware components, such as the processor 810, bus 805, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 800 is a small, handheld computing device, a desktop computer, or a computer server. When the processor 810 executes instructions to perform “operations”, the processor 810 can perform the operations directly and/or facilitate, direct, or cooperate with another device or component to perform the operations.

Although the exemplary embodiment(s) described herein employs the hard disk 830, other types of computer-readable storage devices which can store data that are accessible by a computer, such as magnetic cassettes, flash memory cards, digital versatile disks (DVDs), cartridges, random access memories (RAMs) 825, read only memory (ROM) 820, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 800, an input device 845 represents any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems enable a user to provide multiple types of input to communicate with the computing device 800. The communications interface 840 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 810. The functions these blocks represent may be provided through the use of either shared or dedicated hardware, including, but not limited to, hardware capable of executing software and hardware, such as a processor 810, that is purpose-built to operate as an equivalent to software executing on a general purpose processor. For example the functions of one or more processors presented in FIG. 8A may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 820 for storing software performing the operations described below, and random access memory (RAM) 825 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8A can practice all or part of the recited methods, can be a part of the recited systems, and/or can operate according to instructions in the recited tangible computer-readable storage devices. Such logical operations can be implemented as modules configured to control the processor 810 to perform particular functions according to the programming of the module. For example, FIG. 8A illustrates three modules Mod1 832, Mod2 834 and Mod3 836 which are modules configured to control the processor 810. These modules may be stored on the storage device 830 and loaded into RAM 825 or memory 815 at runtime or may be stored in other computer-readable memory locations.

One or more parts of the example computing device 800, up to and including the entire computing device 800, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 810 can include all types of processors disclosed herein, including a virtual processor. However, when referring to a virtual processor, the processor 810 includes the software components associated with executing the virtual processor in a virtualization layer and underlying hardware necessary to execute the virtualization layer. The system 800 can include a physical or virtual processor 810 that receive instructions stored in a computer-readable storage device, which cause the processor 810 to perform certain operations. When referring to a virtual processor 810, the system also includes the underlying physical hardware executing the virtual processor 810.

FIG. 8B illustrates an example computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 852, representative of any number of physically and/or logically distinct resources capable of executing software, firmware, and hardware configured to perform identified computations. Processor 852 can communicate with a chipset 854 that can control input to and output from processor 852. In this example, chipset 854 outputs information to output device 862, such as a display, and can read and write information to storage device 864, which can include, for example, magnetic media, and solid state media. Chipset 854 can also read data from and write data to RAM 866. A bridge 856 for interfacing with a variety of user interface components 885 can be provided for interfacing with chipset 854. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 854 can also interface with one or more communication interfaces 860 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 852 analyzing data stored in storage device 864 or RAM 866. Further, the machine can receive inputs from a user via user interface components 885 and execute appropriate functions, such as browsing functions by interpreting these inputs using processor 852.

It can be appreciated that example systems 800 and 850 can have more than one processor 810, 852 or be part of a group or cluster of computing devices networked together to provide greater processing capability.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices

Numerous statements are examples are provided herein to enhance the understanding of the present disclosure. A specific set of statements are provided as follows

Statement 1: A method comprising generating a respective graph based on a topology of a work environment, wherein each respective graph comprises a plurality of computing devices, each of the plurality of computing devices is coupled with at least one of one or more sensors, and one or more actuators, and one or more models; collecting, via the plurality of computing devices, respective parameters associated with at least one of the one or more of the plurality of computing devices, the one or more sensors, the one or more actuators, and the one or more models; identifying an environmental anomaly associated with at least one of the sensors or models; generating, based on the respective graph and respective parameters, a decision tree based on the environmental anomaly; and determining a cause of the environmental anomaly based on the decision tree.

Statement 2: A method in accordance with Statement 1, wherein the work environment is selected from the group consisting of a field comprising a plurality of wells, a pipeline, a collection line, a network of pipelines, a network of collection lines, a storage device, a network of storage devices, and combinations thereof.

Statement 3: A method in accordance with Statement 1 or Statement 2, further comprising modifying, based on the cause of the environmental anomaly, an operation of at least one of the actuators.

Statement 4: A method in accordance with Statements 1-3, wherein the environmental anomaly comprises the presence of a material selected from the group consisting of produced water, carbon dioxide (CO₂), heavy metals, radioactive materials, salts, plumes, hydrocarbons, flow assurance chemicals, surfactants, proppants, carrier fluids, hydraulic fracture fluids, sand, and combinations thereof.

Statement 5: A method in accordance with Statements 1-4, further comprising determining a source of the environmental anomaly.

Statement 6: A method in accordance with Statements 1-5, further comprising containing the environmental anomaly.

Statement 7: A method in accordance with Statements 1-6, further comprising generating a compliance report based on the environmental anomaly; and transmitting, via at least one of the plurality of computing devices, the compliance report to a government agency.

Statement 8: A method in accordance with Statements 1-7, further comprising transmitting, from at least one of the plurality of computing devices, a signal to one or more mobile sensors; and deploying the one or more mobile sensors to the location of the environmental anomaly.

Statement 9: A system comprising a work environment having a topology comprising a plurality of computing devices coupled with at least one of one or more sensors, one or more actuators, and one or more models; one or more processors, communicatively coupled with the computing devices, and having a memory having stored therein instructions which, when executed, cause the one or more processors to generate, based on the topology, a graph for the work environment; collect respective parameters associated with the plurality of computing devices and the at least one of the one or more sensors and the one or more actuators; identify an environmental anomaly associated with at least one of the one or more sensors; generate, based on the respective graph and respective parameters, a decision tree based on the environmental anomaly; and determine a cause of the environmental anomaly based on the decision tree.

Statement 10: A system in accordance with Statement 9, wherein the work environment is selected from the group consisting of a field comprising a plurality of wells, a pipeline, a collection line, a network of pipelines, a network of collection lines, a storage device, a network of storage devices, and combinations thereof.

Statement 11: A system in accordance with Statement 9 or Statement 10, wherein the instructions further cause the processor to modify, based on the cause of the environmental anomaly, an operation of at least one of the actuators.

Statement 12: A system in accordance with Statements 9-11, wherein the instructions further cause the processor to detect a condition in the work environment; and identify the environmental anomaly based on the detected condition.

Statement 13: A system in accordance with Statements 9-12, wherein the instructions further cause the processor to determine, based on the cause of the environmental anomaly, a source of the condition.

Statement 14: A system in accordance with Statements 9-13, wherein the instructions further cause the processor to contain the source of the environmental anomaly.

Statement 15: A system in accordance with Statements 9-14, wherein the instructions further cause the processor to generate a compliance report based on the environmental anomaly; and transmit, via at least one of the plurality of computing devices, the compliance report to a government agency.

Statement 16: A system in accordance with Statements 9-15, wherein the environmental anomaly comprises the presence of a material selected from the group consisting of produced water, carbon dioxide (CO₂), heavy metals, radioactive materials, salts, plumes, hydrocarbons, flow assurance chemicals, surfactants, proppants, carrier fluids, hydraulic fracture fluids, sand, and combinations thereof.

Statement 17: A system in accordance with Statements 9-16, further comprising one or more mobile sensors communicatively coupled with the plurality of computing devices.

Statement 18: A system in accordance with Statements 9-17, wherein the instructions further cause the processor to send a signal from the plurality of computing devices to the one or more mobile sensors when the environmental anomaly is detected; and direct the one or more mobile sensors to the location of the environmental anomaly.

Statement 19: A non-transitory computer-readable storage medium having instructions stored thereon which, when executed by one or more processors, cause the one or more processors to generate a graph for a work environment based on a topology of a field, the graph comprising a plurality of computing devices each of which is coupled with at least one of one or more sensors and one or more actuators; collect respective parameters associated with the plurality of computing devices and the at least one of the one or more sensors, the one or more actuators, and one or more models; identify an environmental anomaly associated with at least one of the plurality of computing devices, the one or more sensors, and the one or more actuators; generate, based on the graph and respective parameters, a decision tree based on the environmental anomaly; and determine a cause of the environmental anomaly based on the decision tree.

Statement 20: A non-transitory computer-readable storage medium in accordance with Statement 19, wherein the instructions further cause the processor to modify, based on the environmental anomaly, an operation of at least one actuators; generate a compliance report based on the environmental anomaly; and transmit, via at least one of the plurality of computing devices, the compliance report to a government agency.

Statement 21: A non-transitory computer-readable storage medium in accordance with Statement 19 or Statement 20, wherein the work environment is selected from the group consisting of a field comprising a plurality of wells, a pipeline, a collection line, a network of pipelines, a network of collection lines, a storage device, a network of storage devices, and combinations thereof.

Statement 22: A non-transitory computer-readable storage medium in accordance with Statements 19-21, wherein the environmental anomaly comprises the presence of a material selected from the group consisting of produced water, carbon dioxide (CO₂), heavy metals, radioactive materials, salts, plumes, hydrocarbons, flow assurance chemicals, surfactants, proppants, carrier fluids, hydraulic fracture fluids, sand, and combinations thereof.

Statement 23: A non-transitory computer-readable storage medium in accordance with Statements 19-22, wherein the instructions further cause the processor to contain the environmental anomaly.

What is claimed:

1. A method comprising:
generating a respective graph based on a topology of a work environment, wherein each respective graph comprises a plurality of computing devices, each of the plurality of computing devices is coupled with at least one of one or more sensors, one or more actuators, and one or more models;
collecting, via the plurality of computing devices, respective parameters associated with at least one of the one or more of the plurality of computing devices, the one or more sensors, the one or more actuators, and the one or more models;
identifying an environmental anomaly associated with at least one of the sensors or models;
generating, based on the respective graph and respective parameters, a decision tree based on the environmental anomaly; and
determining a cause of the environmental anomaly based on the decision tree.

2. The method of claim 1, wherein the work environment is selected from the group consisting of a field comprising a plurality of wells, a pipeline, a collection line, a network of pipelines, a network of collection lines, a storage device, a network of storage devices, and combinations thereof.

3. The method of claim 1, further comprising modifying, based on the cause of the environmental anomaly, an operation of at least one of the actuators.

4. The method of claim 1, wherein the environmental anomaly comprises the presence of a material selected from the group consisting of produced water, carbon dioxide (CO₂), heavy metals, radioactive materials, salts, plumes, hydrocarbons, flow assurance chemicals, surfactants, proppants, carrier fluids, hydraulic fracture fluids, sand, and combinations thereof.

5. The method of claim 4, further comprising determining a source of the environmental anomaly.

6. The method of claim 5, further comprising containing the environmental anomaly.

7. The method of claim 1, further comprising:
generating a compliance report based on the environmental anomaly; and
transmitting, via at least one of the plurality of computing devices, the compliance report to a government agency.

8. The method of claim 1, further comprising:
transmitting, from at least one of the plurality of computing devices, a signal to one or more mobile sensors; and
deploying the one or more mobile sensors to the location of the environmental anomaly.

9. A system comprising:
a work environment having a topology comprising a plurality of computing devices coupled with at least one of one or more sensors, one or more actuators, and one or more models;
one or more processors, communicatively coupled with the computing devices, and having a memory having stored therein instructions which, when executed, cause the one or more processors to:
generate, based on the topology, a graph for the work environment;
collect respective parameters associated with the plurality of computing devices and the at least one of the one or more sensors and the one or more actuators;
identify an environmental anomaly associated with at least one of the one or more sensors;
generate, based on the graph and respective parameters, a decision tree based on the environmental anomaly; and
determine a cause of the environmental anomaly based on the decision tree.

10. The system of claim 9, wherein the work environment is selected from the group consisting of a field comprising a plurality of wells, a pipeline, a collection line, a network of pipelines, a network of collection lines, a storage device, a network of storage devices, and combinations thereof.

11. The system of claim 9, wherein the instructions further cause the processor to modify, based on the cause of the environmental anomaly, an operation of at least one of the actuators.

12. The system of claim 9, wherein the instructions further cause the processor to:
detect a condition in the work environment; and
identify the environmental anomaly based on the detected condition.

13. The system of claim 12, wherein the instructions further cause the processor to determine, based on the cause of the environmental anomaly.

14. The system of claim 13, wherein the instructions further cause the processor to contain the source of the environmental anomaly.

15. The system of claim 9, wherein the instructions further cause the processor to:
generate a compliance report based on the environmental anomaly; and
transmit, via at least one of the plurality of computing devices, the compliance report to a government agency.

16. The system of claim 9, wherein the environmental anomaly comprises the presence of a material selected from the group consisting of produced water, carbon dioxide (CO₂), heavy metals, radioactive materials, salts, plumes, hydrocarbons, flow assurance chemicals, surfactants, proppants, carrier fluids, hydraulic fracture fluids, sand, and combinations thereof.

17. The system of claim 9, further comprising one or more mobile sensors communicatively coupled with the plurality of computing devices.

18. The system of claim 17, wherein the instructions further cause the processor to:
send a signal from the plurality of computing devices to the one or more mobile sensors when the environmental anomaly is detected; and
direct the one or more mobile sensors to the location of the environmental anomaly.

19. A non-transitory computer-readable storage medium having instructions stored thereon which, when executed by one or more processors, cause the one or more processors to:
generate a graph for a work environment based on a topology of a field, the graph comprising a plurality of computing devices each of which is coupled with at least one of one or more sensors and one or more actuators;
collect respective parameters associated with the plurality of computing devices and the at least one of the one or more sensors, the one or more actuators, and one or more models;
identify an environmental anomaly associated with at least one of the plurality of computing devices, the one or more sensors, and the one or more actuators;
generate, based on the graph and respective parameters, a decision tree based on the environmental anomaly; and
determine a cause of the environmental anomaly based on the decision tree.

20. The non-transitory computer-readable storage medium of claim 19, wherein the instructions further cause the processor to:
modify, based on the environmental anomaly, an operation of at least one actuators;
generate a compliance report based on the environmental anomaly; and
transmit, via at least one of the plurality of computing devices, the compliance report to a government agency.

21. The non-transitory computer-readable storage medium of claim 19, wherein the work environment is selected from the group consisting of a field comprising a plurality of wells, a pipeline, a collection line, a network of pipelines, a network of collection lines, a storage device, a network of storage devices, and combinations thereof.
